(19) United States
(12) Patent Application Publication
(10) Pub. No.: US 2017/0280366 A1
(43) Pub. Date: Sep. 28, 2017

(54) ACHIEVING DUAL SIM DUAL ACTIVE OPERATION IN AN LTE + LTE DEVICE BY DOWNGRADING USER EQUIPMENT CATEGORY TO 1 FOR ONE SIM

(71) Applicant: QUALCOMM Incorporated, San Diego, CA (US)

(72) Inventors: Debesh Kumar Sahu, Hyderabad (IN); Sagar, Hyderabad (IN); Tushar Gupta, Hyderabad (IN)

(21) Appl. No.: 15/078,775

(22) Filed: Mar. 23, 2016

(51) Int. Cl. H04W 36/32; H04W 60/00; H04W 60/06

(52) U.S. Cl. CPC H04W 36/32; H04W 60/06; H04W 60/005

(57) ABSTRACT

A method for performing a dedicated data subscription (DDS) switch on a multi subscriber identity module multi-active (MSMA) mobile communication device includes: initiating a DDS switch from a first subscription to a second subscription; determining whether a first communication network associated with the first subscription supports user equipment (UE) capability update via a tracking area update (TAU) procedure; in response to determining that the first communication network supports UE capability update via a TAU procedure, initiating a TAU procedure on the first subscription with the first communication network; and reporting a UE category 1 capability to the first communication network on the first subscription for the mobile communication device during the TAU procedure on the first subscription.

### BACKGROUND

An incoming Voice over Long Term Evolution (VoLTE) call to a mobile communication device is indicated by a page from a communication network. Upon receiving the page, the mobile communication may set up a packet switched (PS) connection and may receive a SIP_INVITE indicating a VoLTE call request. To decode a SIP_INVITE, the mobile communication device switches from an idle state to a connected/traffic state. A user equipment (UE) category 4 dual subscriber identity module (SIM) dual active (DSDA) mobile communication device having two LTE subscriptions with VoLTE enabled may use one receive (RX) chain to decode the SIP_INVITE, but two RX chains to enter traffic mode to receive the VoLTE call on one subscription. However, a category 1 LTE device uses one RX chain to decode an incoming data packet successfully.

With limited RX chains it may not be possible for the UE category 4 DSDA mobile communication device to concurrently support a second VoLTE call on a second subscription. For example, a DSDA mobile communication device may have two transmit (TX) chains and three RX chains, and a first LTE subscription on a first SIM may be a dedicated data subscription (DDS). With an active data call on the first SIM, two RX chains and one TX chain may be assigned to the first LTE subscription on the first SIM leaving one RX chain and one TX chain left for the second subscription.

If a page for an incoming VoLTE call is received by a second LTE subscription on the second SIM, the subsequent SIP_INVITE may be decoded using the one remaining RX chain. However, two RX chains may be used by the UE category 4 DSDA mobile communication device to enter traffic mode to receive the VoLTE call. Since only one RX chain is available for the second subscription, the mobile communication device cannot enter traffic mode and therefore cannot achieve DSDA behavior (i.e., maintain calls on both subscriptions).

### SUMMARY

Apparatuses and methods for achieving DSDA operation for a mobile communication device by downgrading the UE category to 1 are provided.

According to various aspects there is provided a method for performing a dedicated data subscription (DDS) switch on a multi subscriber identity module multi-active (MSMA) mobile communication device. In some aspects, the method may include: initiating a DDS switch from a first subscription to a second subscription; determining whether a first communication network associated with the first subscription supports user equipment (UE) capability update via a tracking area update (TAU) procedure; in response to determining that the first communication network supports UE capability update via a TAU procedure, initiating a TAU procedure on the first subscription with the first communication network; and reporting a UE category 1 capability to the first communication network on the first subscription for the mobile communication device during the TAU procedure on the first subscription.

According to various aspects there is provided a multi subscriber identity module multi-active (MSMA) mobile communication device having a first long term evolution (LTE) subscription and a second LTE subscription. In some aspects, the mobile communication device may include: a plurality of receive (RX) chains; a memory operably connected to the plurality of RX chains; and a control unit operably connected to the plurality of RX chains and the memory.

The control unit may be configured to: initiate a DDS switch from the first LTE subscription to the second LTE subscription; determine whether a first communication network associated with the first LTE subscription supports user equipment (UE) capability update via a tracking area update (TAU) procedure; in response to determining that the first communication network supports UE capability update via a TAU procedure, initiate a TAU procedure on the first LTE subscription with the first communication network; and report a UE category 1 capability to the first communication network on the first LTE subscription for the mobile communication device during the TAU procedure on the first LTE subscription

According to various aspects there is provided a method for receiving a Voice over Long Term Evolution (VoLTE) call on a user equipment (UE) multi subscriber identity module multi-active (MSMA) mobile communication device having less than four receive chains and a dedicated data subscription (DDS) set to a first subscription. In some aspects, the method may include: entering traffic mode by the first subscription associated with a first communication network; reporting a rank indicator equal to one for the mobile communication device to the first communication network on the first subscription without determining channel conditions; determining channel conditions for the first subscription based on one or more measured parameters; and in response determining that the one or more measured parameters are equal to or greater than a threshold value, assigning one receive chain to the first subscription

Other features and advantages should be apparent from the following description which illustrates by way of example aspects of the various teachings of the disclosure.

### BRIEF DESCRIPTION OF THE DRAWINGS

Aspects and features of the various embodiments will be more apparent by describing examples with reference to the accompanying drawings, in which:

FIG. 1A is a block diagram illustrating a mobile communication device according to various embodiments;

FIG. 1B is a diagram illustrating a network environment for various embodiments;

FIG. 2 is a sequence diagram illustrating a dedicated data subscription (DDS) switch according to various embodiments;

FIG. 3 is a flowchart of a method for performing a dedicated data subscription (DDS) switch on a UE category 4 mobile multi subscriber identity module multi-active (MSMA) communication device according to various embodiments; and

FIG. 4 is a flowchart of a method for receiving Voice over Long Term Evolution (VoLTE) calls on a UE category 4 multi subscriber identity module multi-active (MSMA) mobile communication device according to various embodiments.

### DETAILED DESCRIPTION

While certain embodiments are described, these embodiments are presented by way of example, and are not intended to limit the scope of protection. The apparatuses, methods, and systems described herein may be embodied in a variety of other forms. Furthermore, various omissions, substitutions, and changes in the form of the example methods and systems described herein may be made without departing from the scope of protection.

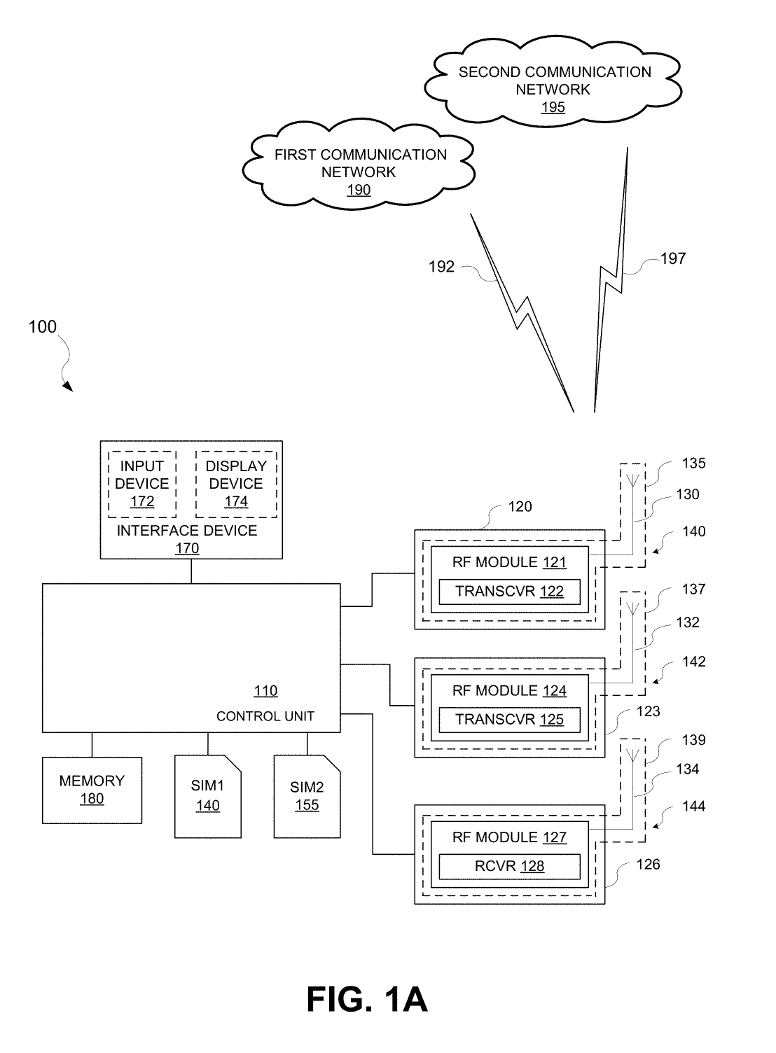

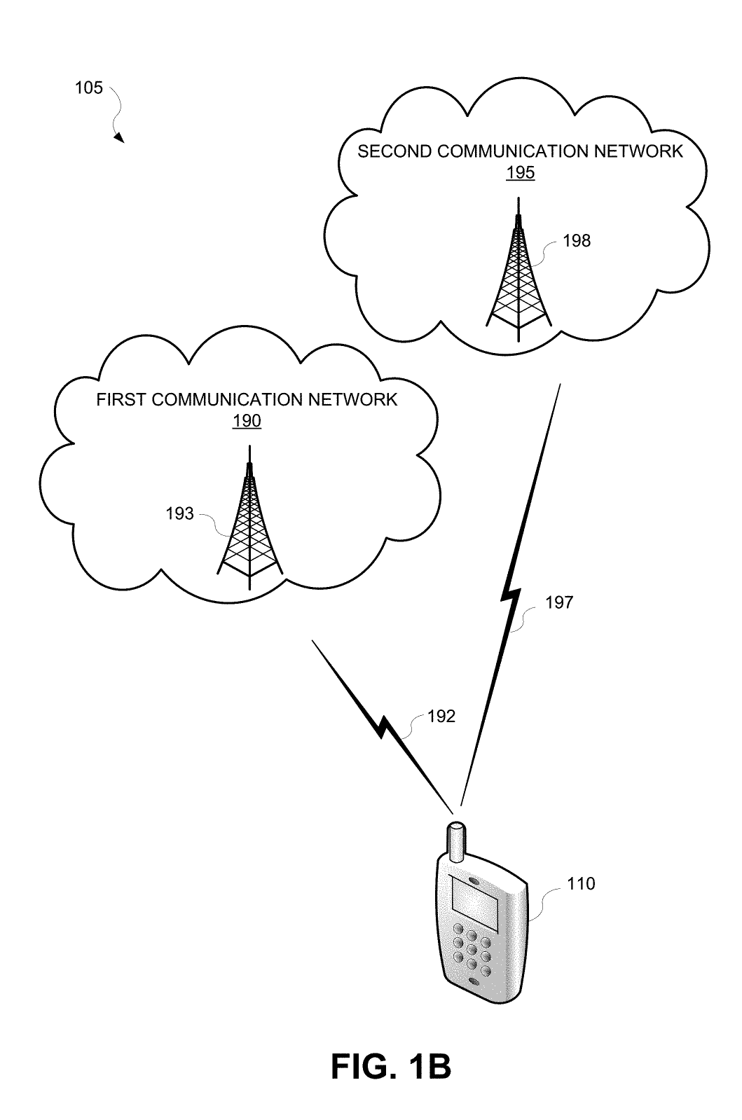

FIG. 1A is a block diagram illustrating a mobile communication device 100 according to various embodiments. As illustrated in FIG. 1, the mobile communication device 100 may include a control unit 110, a first communication unit 120, a second communication unit 123, a third communication unit 126, a first antenna 130, a second antenna 132, a third antenna 134, a first subscriber identity module (SIM) 150, a second SIM 155, a user interface device 170, and a memory 180.

The mobile communication device 100 may be, for example but not limited to, a mobile telephone, smartphone, tablet, computer, etc., capable of communications with one or more wireless networks. One of ordinary skill in the art will appreciate that the mobile communication device 100 may include one or more transceivers (communication units) and may interface with one or more antennas without departing from the scope of protection. The mobile communication device 100 may be a UE category 4 mobile communication device.

The first communication unit 120 may include, for example, but not limited to, a first radio frequency (RF) module 121. The first RF module 121 may include, for example, but not limited to a first transceiver 122. A first RF chain 135 may include, for example, but not limited to the first antenna 130 and the first RF module 121. A first RX chain 140 may include a receiver portion (not shown) of the first transceiver 122, the first RF module 121, and the first antenna 130.

The second communication unit 123 may include, for example, but not limited to, a second RF module 124. The second RF module 124 may include, for example, but not limited to a second transceiver 125. A second RF chain 137 may include, for example, but not limited to the second antenna 132 and the second RF module 124. A second RX chain 142 may include a receiver portion (not shown) of the second transceiver 125, the second RF module 124, and the second antenna 132.

The third communication unit 126 may include, for example, but not limited to, a third RF module 127. The third RF module 127 may include, for example, but not limited to a receiver 128. A third RF chain 139 may include, for example, but not limited to the third antenna 134 and the third RF module 127. A third RX chain 144 may include the receiver 128, the third RF module 127, and the third antenna 134.

One of ordinary skill in the art will appreciate that embodiments of the mobile communication device 100 may include more or less than three antennas without departing from the scope of protection.

A SIM (for example the first SIM 150 and/or the second SIM 155) in various embodiments may be a universal integrated circuit card (UICC) that is configured with SIM and/or universal SIM (USIM) applications, enabling access to global system for mobile communications (GSM) and/or universal mobile telecommunications system (UMTS) networks. The UICC may also provide storage for a phone book and other applications. Alternatively, in a code division multiple access (CDMA) network, a SIM may be a UICC removable user identity module (R-UIM) or a CDMA subscriber identity module (CSIM) on a card. A SIM card may have a CPU, ROM, RAM, EEPROM and I/O circuits. An integrated circuit card identity (ICCID) SIM serial number may be printed on the SIM card for identification. However, a SIM may be implemented within a portion of memory of the mobile communication device 100, and thus need not be a separate or removable circuit, chip, or card.

A SIM used in various embodiments may store user account information, an international mobile subscriber identity (IMSI), a set of SIM application toolkit (SAT) commands, and other network provisioning information, as well as provide storage space for phone book database of the user's contacts. As part of the network provisioning information, a SIM may store home identifiers (e.g., a system identification number (SID)/network identification number (NID) pair, a home public land mobile network (HPLMN) code, etc.) to indicate the SIM card network operator provider.

The first SIM 150 may associate the first communication unit 120 with a first subscription (Sub1) 192 associated with a first radio access technology (RAT) on a first communication network 190 and the second SIM 155 may associate the second communication unit 123 with a second subscription (Sub2) 197 associated with a second RAT on a second communication network 195.

For convenience, the various embodiments are described in terms of DSDA mobile communication devices. However, one of ordinary skill in the art will appreciate that the various embodiments may be extended to Multi-SIM Multi-Active (MSMA) mobile communication devices without departing from the scope of protection.

The first communication network 190 and the second communication network 195 may be operated by the same or different service providers, and/or may support the same or different RATs, for example, but not limited to, GSM, CDMA, wideband CDMA (WCDMA), and long term evolution (LTE).

The user interface device 170 may include an input device 172, for example, but not limited to a keyboard, touch panel, or other human interface device, and a display device 174, for example, but not limited to, a liquid crystal display (LCD), light emitting diode (LED) display, or other video display. One of ordinary skill in the art will appreciate that other input and display devices may be used without departing from the scope of the various embodiments.

The control unit 110 may be configured to control overall operation of the mobile communication device 100 including control of the first, second, and third communication units 120, 123, 126, the user interface device 170, and the memory 180. The control unit 110 may be a programmable device, for example, but not limited to, a microprocessor (e.g., general-purpose processor, baseband modem processor, etc.) or microcontroller.

The memory 180 may be configured to store operating systems and/or application programs for operation of the mobile communication device 100 that are executed by the control unit 110, as well as to store application data and user data.

FIG. 1B is a diagram illustrating a network environment 105 for various embodiments. Referring to FIGS. 1A and 1B, a mobile communication device 100 may be configured to communicate with a first communication network 190 on Sub1 92 and a second communication network 195 on Sub2197. One of ordinary skill in the art will appreciate that the mobile communication device may configured to communicate with more than two communication networks and may communicate on more than two subscriptions without departing from the scope of protection.

The first communication network 190 and the second communication network 195 may implement the same or different radio RATs. For example, the first communication network 190 may be LTE network and Sub1 192 may be an LTE subscription. The second communication network 195 may also be an LTE network and Sub2 197 may be an LTE subscription. In various embodiments, Voice over LTE (VoLTE) may be enabled on both Sub1 192 and Sub2 197.

The first communication network 190 may include one or more base transceiver stations (BTSs) including, for example, but not limited to, a first BTS 193. The second communication network 195 may also include one or more BTSs, including, for example, but not limited to, a second BTS 198. A person having ordinary skill in the art will appreciate that the network environment 105 may include any number of communication networks, mobile communication devices, and BTSs without departing from the scope of the various embodiments.

The mobile communication device 100 may attempt to acquire the first communication network 190 and camp on the first BTS 193. The mobile communication device 100 may also attempt to acquire the second communication network 195 and camp on the second BTS 198. A person having ordinary skill in the art will appreciate that the acquisition of the first communication network 190 performed on Sub1192 may be independent of the acquisition of the second communication network 195 performed on Sub2 197. Furthermore, the mobile communication device 100 may attempt to acquire the first communication network 190 on Sub1192 and the second communication network 195 on Sub2 197.

A UE category 4 LTE mobile communication device may decode a SIP_INVITE using one RX chain, but may decode incoming data packets (e.g., receive an incoming VoLTE call) using two RX chains. With a limited number of RX chains, it may not be possible for a UE category 4 LTE mobile communication device to support concurrent VoLTE calls on more than one subscription. On the other hand, a UE category 1 LTE mobile communication device may decode a SIP_INVITE and decode incoming data packets (i.e., inter-into traffic mode) using one RX chain.

In various examples, for a DSDA mobile communication device (e.g., the mobile communication device 100) one subscription may be selected as a DDS and assigned two RX chains (i.e., UE category 4) while the other subscription may be downgraded to a UE category 1 and assigned one RX chain. By lowering the category of the non-DDS LTE subscription, one RX chain may be provided for VoLTE on the non-DDS subscription and two RX chains may be provided for the data call on the DDS subscription. Thus, if the category of the second SIM (e.g., the second SIM 155) LTE stack can be lowered, then the second subscription (e.g., Sub2 197) can enter the traffic state using one RX chain and decode the SIP_INVITE in the traffic state and achieve DSDA behavior.

In one example, the category of the second subscription (e.g., Sub2 197) on the second SIM (e.g., the second SIM 155) is downgraded when the DDS is set to the first SIM (e.g., the first SIM 150) or vice-versa. Since a VoLTE call does not typically use high data rates, there will be a limited effect on the second SIM (e.g., the second SIM 155). Two methods may be used to downgrade a SIM to category 1: 1) the UE may use a TAU procedure to update the new UE category to the communication network (e.g., the first communication network 190 or the second communication network 195), and 2) the UE may detach from the communication network and attach again to the communication network to update the new UE category.

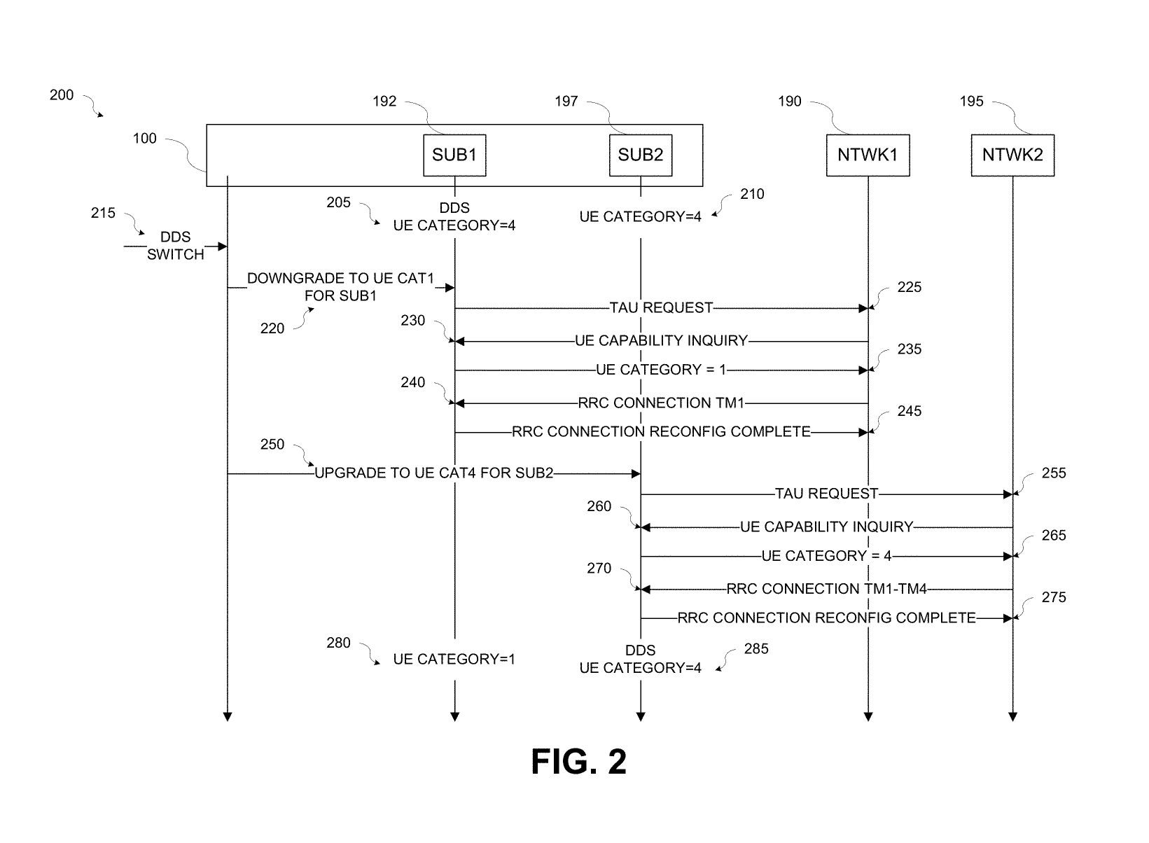

FIG. 2 is a sequence diagram illustrating a dedicated data subscription (DDS) switch 200 according to various examples and more particularly to the first method of lowering a category discussed above. Referring to FIGS. 1A-2, at block 205, Sub1 192 may be the DDS and may have initially reported a UE category 4. At block 210, Sub2 197 may also have initially reported a UE category 4. At block 215, the mobile communication device 100 may receive a DDS switch instruction to switch the DDS from Sub1 192 to Sub2 197. For example, a user may manually provide a DDS switch instruction. Alternatively, the DDS switch may be initiated by, for example, but not limited to, reception of a multimedia messaging service (MMS) message indication.

After receiving the DDS switch instruction, at block 220 the mobile communication device 100 may downgrade Sub1 192 to UE category 1. At block 225 the mobile communication device 100 may initiate a tracking area update (TAU) procedure on Sub1 192 by issuing a TAU request to the first communication network 190. At block 230 the first communication network 190 may respond with a UE capability inquiry. At block 235 the mobile communication device 100 may respond on Sub1 192 with a UE category equal to 1, thereby downgrading Sub1 192 to UE category 1. In response, at block 240 the first communication network 190 may set the radio resource control (RRC) connection to transmission mode 1 (TM1). At block 245 the mobile communication device may send an RRC connection reconfiguration complete message on Sub1 192 to the first communication network 190 thereby completing the TAU procedure on Sub1 192.

Similarly, at block 250 the mobile communication device 100 may upgrade (or maintain) Sub2 197 to UE category 4. At block 255 the mobile communication device 100 may initiate a tracking area update (TAU) procedure on Sub2 197 by issuing a TAU request to the second communication network 195. At block 260 the second communication network 195 may respond with a UE capability inquiry. At block 265 the mobile communication device 100 may respond on Sub2 197 with a UE category equal to 4, thereby upgrading (or maintaining) Sub2 197 to UE category 4. In response, at block 270 the second communication network 195 may set the RRC connection to any transmission mode (TM) (e.g., TM1-TM4). At block 275 the mobile communication device may send an RRC connection reconfiguration complete message on Sub2 197 to the second communication network 195 thereby completing the TAU procedure on Sub2 197. Accordingly, at block 280 Sub1 192 may report a UE category equal to 1 and at block 285 Sub2 197 may be the DDS and may report a UE category equal to 4.

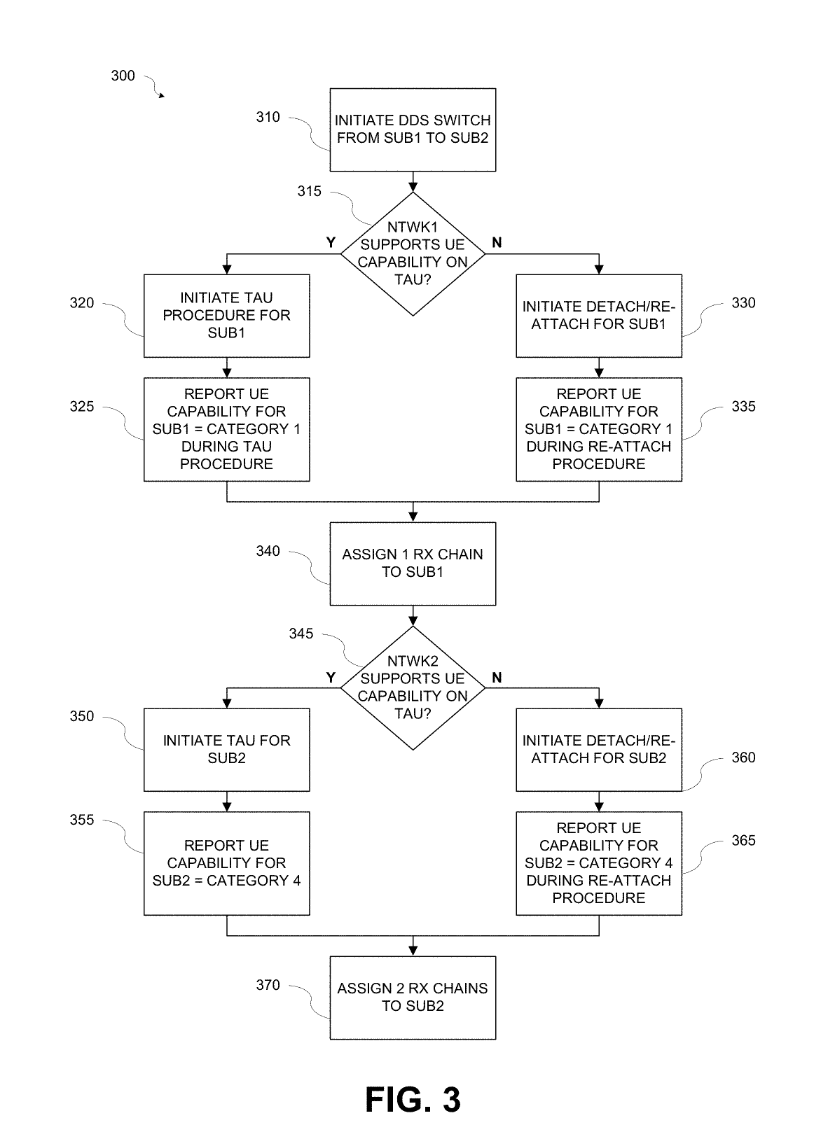

FIG. 3 is a flowchart of a method 300 for performing a dedicated data subscription (DDS) switch on a UE category 4 multi subscriber identity module multi-active (MSMA) mobile communication device according to various and more particularly to the both methods of lowering a category discussed above. Referring to FIGS. 1A, 1B, and 3, at block 310 the mobile communication device 100 may initiate a DDS switch from Sub1 192 to Sub2 197. For example, a user may manually provide a DDS switch instruction. Alternatively, the DDS switch may be initiated by, for example, but not limited to, an instruction from the control unit 110 after reception by the second communication unit 123 of a multimedia messaging service (MMS) message indication on Sub2 197.

At block 315 the control unit 110 may determine if the first communication network 190 (i.e., NTWK1) supports UE capability information on TAU. In response to determining that the first communication network 190 supports UE capability information on TAU (315-Y), at block 320 the control unit 110 may initiate a TAU procedure for Sub1 192. At block 325, during the TAU procedure the control unit 110 may report a UE capability for Sub1 192 equal to UE category 1 to the first communication network 190.

In response to determining that the first communication network 190 does not support UE capability information on TAU (315-N), at block 330 the control unit 110 may initiate a detach/re-attach procedure for Sub1 192. At block 335, during a re-attach portion of the detach/re-attach procedure the control unit 110 may report a UE capability equal to UE category 1 for Sub1 192 to the first communication network 190. At block 340, the control unit 110 may assign one RX chain (e.g., the first RX chain 140) to Sub1 192. With the mobile communication device 100 configured as UE category 1 for Sub1 192, the mobile communication device 100 may be capable of receiving and decoding a SIP_INVITE and entering traffic mode to receive a VoLTE call using one RX chain (e.g., the first RX chain 140) on Sub1 192.

At block 345 the control unit 110 may determine if the second communication network 195 (i.e., NTWK2) supports UE capability information on TAU. In response to determining that the second communication network 195 supports UE capability information on TAU (345-Y), at block 350 the control unit 110 may initiate a TAU procedure for Sub2 197. At block 355, during the TAU procedure the control unit 110 may report a UE capability for Sub1 197 equal to UE category 4 to the second communication network 195.

In response to determining that the second communication network 195 does not support UE capability information on TAU (345-N), at block 360 the control unit 110 may initiate a detach/re-attach procedure for Sub2 197. At block 365, during a re-attach portion of the detach/re-attach procedure the control unit 110 may report a UE capability equal to UE category 4 for Sub2 197 to the second communication network 195. At block 370, the control unit 110 may assign two RX chains (e.g., the second RX chain 142 and the third RX chain 144) to Sub2 197. Accordingly, with the mobile communication device 100 configured as UE category 4 for Sub2 197, Sub2 197 may have two RX chains (e.g., the second RX chain 142 and the third RX chain 144) available to decode a SIP_INVITE and enter traffic mode to receive a VoLTE call.

One of ordinary skill in the art will appreciate that processor executable instructions for executing the method 300 by the control unit 110 may be stored in the memory 180 operably connected to the control unit 110.

In various examples, for a DSDA mobile communication device (e.g., the mobile communication device 100) one subscription (e.g., Sub2 197) may be selected as the DDS and the non-DDS subscription (e.g., Sub1 192) may report a rank indicator (RI) equal to 1 for all traffic conditions without calculating any channel parameters. The non-DDS subscription may subsequently be assigned one RX chain or two RX chains.

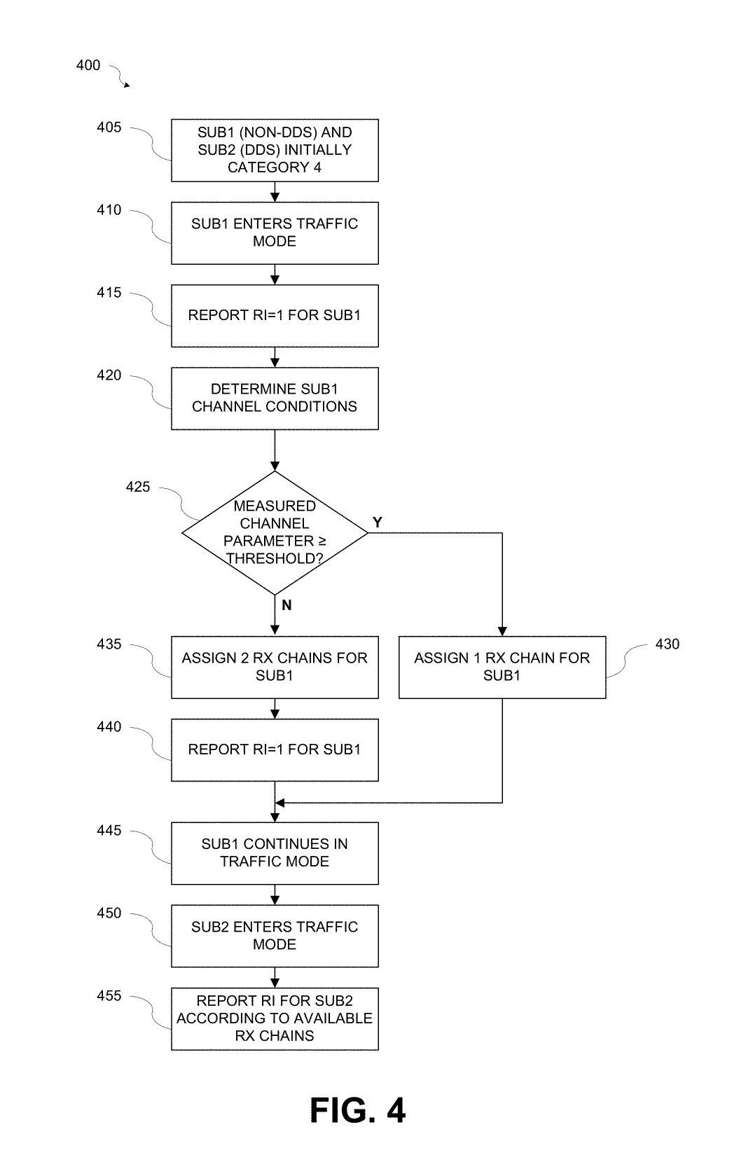

FIG. 4 is a flowchart of a method 400 for receiving Voice over Long Term Evolution (VoLTE) calls on a UE category 4 multi subscriber identity module multi-active (MSMA) mobile communication device according to various examples. Referring to FIGS. 1A, 1B, and 4, at block 405, Sub1 192 may be a non-DDS and Sub2 197 may be a DDS subscription. For both Sub1 192 and Sub2 197, the control unit 110 may initially report a UE category 4 for the mobile communication device 100.

At block 410, the control unit 110 may cause Sub1 192 to enter traffic mode. For LTE, the mobile communication device may periodically report a rank indictor (RI) to the network. The RI may equal one (i.e., one data stream received on one RX chain), or the RI may equal two (i.e., two data streams received on two RX chains). At block 415 the control unit 110 may report a rank indicator (RI) equal to 1 for Sub1 192. For example, the control unit 110 may report an RI equal to 1 to the first communication network 190 for Sub1 192 for all traffic without calculating any channel parameters to determine channel conditions.

At block 420, the control unit 110 may determine the channel conditions for Sub1 192. For example, the control unit 110 may cause the communication unit (e.g., the first communication unit 120) for Sub1 192 to measure one or more channel parameters, for example, but not limited to, the Reference Signal Received Power (RSRP), signal to noise ratio (SNR), etc. At block 425, the control unit 110 may determine whether the one or more measured channel parameters (e.g., the RSRP, SNR, etc.) is greater than or equal to a threshold value. For example, the control unit 110 may determine whether the measured channel parameter is greater than or equal to a value in a range of −100 dBm to −80 dBm. In response to determining that the measured channel parameter is greater than or equal to the threshold value (425-Y), at block 430 the control unit 110 may assign one RX chain (e.g., the first RX chain 140) to Sub1 192.

In response to determining that the measured channel parameter s not greater than or equal to the threshold value (425-N), at block 435 the control unit 110 may assign two RX chains (e.g., the second RX chain 142 and the third RX chain 144) to Sub1 192. However, at block 440 Sub1 192 may still report an RI equal to 1. Thus, even though two RX chains may be assigned to Sub1 192 the control unit 110 may report an RI equal to 1 to the first communication network 190 for Sub1 192. Assigning two RX chains to the non-DDS subscription Sub1 192 may improve the ability of the mobile communication device 100 to sustain a VoLTE call on the non-DDS subscription. At block 445 Sub1 192 may continue in traffic mode at block 435.

At block 450 Sub2 197 may enter traffic mode. For example, a page may be received on Sub2 197. Sub2 197 may set up a PS connection and receive a SIP_INVITE indicating a VoLTE call request. Sub2 197 may then enter traffic mode to receive the VoLTE call. At block 455 the control unit 110 may report an RI to the communication network (e.g., the second communication network 195) according to the remaining number of RX chains. For example, if the control unit 110 assigns one RX chain to Sub1 192, the control unit 110 may report an RI equal to 2 to the second communication network 195 for Sub2 197. If the control unit 110 assigns two RX chains to Sub1 192, the control unit 110 may report an RI equal to 1 to the second communication network 195 for Sub2 197. Thus, the control unit 110 may give the VoLTE call a higher priority in assignment of the RX chains.

One of ordinary skill in the art will appreciate that processor executable instructions for executing the method 400 by the control unit 110 may be stored in the memory 180 operably connected to the control unit 110.

The methods 300 and 400, respectively, may be embodied on a non-transitory computer readable medium, for example, but not limited to, the memory 180 or other non-transitory computer readable medium known to those of skill in the art, having stored therein a program including computer executable instructions for making a processor, computer, or other programmable device execute the operations of the methods.

The various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment.

The accompanying claims and their equivalents are intended to cover such forms or modifications as would fall within the scope and spirit of the protection. For example, the example apparatuses, methods, and systems disclosed herein can be applied to multi-SIM wireless devices subscribing to multiple communication networks and/or communication technologies. The various components illustrated in the figures may be implemented as, for example, but not limited to, software and/or firmware on a processor, ASIC/FPGA/DSP, or dedicated hardware. Also, the features and attributes of the specific example embodiments disclosed above may be combined in different ways to form additional embodiments, all of which fall within the scope of the present disclosure.

The foregoing method descriptions and the process flow diagrams are provided merely as illustrative examples and are not intended to require or imply that the operations of the various embodiments must be performed in the order presented. As will be appreciated by one of skill in the art the order of operations in the foregoing embodiments may be performed in any order. Words such as “thereafter,” “then,” “next,” etc., are not intended to limit the order of the operations; these words are simply used to guide the reader through the description of the methods. Further, any reference to claim elements in the singular, for example, using the articles “a,” “an,” or “the” is not to be construed as limiting the element to the singular.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the various embodiments.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more exemplary aspects, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in processor-executable instructions that may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

Although the present disclosure provides certain example embodiments and applications, other embodiments that are apparent to those of ordinary skill in the art, including embodiments which do not provide all of the features and advantages set forth herein, are also within the scope of this disclosure. Accordingly, the scope of the present disclosure is intended to be defined by reference to the appended claims.

What is claimed is:

1. A method for performing a dedicated data subscription (DDS) switch on a user equipment (UE) multi subscriber identity module multi-active (MSMA) mobile communication device, the method comprising:
initiating a DDS switch from a first subscription to a second subscription;
determining whether a first communication network associated with the first subscription supports UE capability update via a tracking area update (TAU) procedure;
in response to determining that the first communication network supports UE capability update via a TAU procedure, initiating the TAU procedure on the first subscription with the first communication network; and
reporting a UE category 1 capability to the first communication network on the first subscription for the mobile communication device during the TAU procedure on the first subscription.

2. The method of claim 1, further comprising:
in response to determining that the first communication network does not support UE capability update via a TAU procedure,
initiating a detach/re-attach procedure for the first subscription on the first communication network; and
reporting the UE category 1 capability on the first subscription for the mobile communication device during a re-attach portion of the detach/re-attach procedure for the first subscription.

3. The method of claim 2, further comprising:
assigning one RX chain to the first subscription.

4. The method of claim 1, further comprising:
determining whether a second communication network associated with the second subscription supports UE capability update via a TAU procedure;
in response to determining that the second communication network supports UE capability update via a TAU procedure, initiating the TAU procedure on the second subscription to the second communication network; and
reporting a UE category 4 capability on the second subscription for the mobile communication device during the TAU procedure on the second subscription.

5. The method of claim 4, further comprising:
in response to determining that the second communication network does not support UE capability update via a TAU procedure,
initiating a detach/re-attach procedure for the second subscription on the second communication network; and
reporting the UE category 4 capability on the second subscription for the mobile communication device during a re-attach portion of the detach/re-attach procedure for the second subscription.

6. The method of claim 5, further comprising:
assigning two RX chains to the second subscription.

7. The method of claim 1, wherein the UE is category 4 and the MSMA mobile communication device has less than four receive chains and the first subscription and the second subscription are long term evolution (LTE) subscriptions.

8. A multi subscriber identity module multi-active (MSMA) mobile communication device having a first long term evolution (LTE) subscription and a second LTE subscription, the mobile communication device comprising:
a plurality of receive (RX) chains;
a memory operably connected to the plurality of RX chains; and
a control unit operably connected to the plurality of RX chains and the memory and configured to:
initiate a DDS switch from the first LTE subscription to the second LTE subscription;
determine whether a first communication network associated with the first LTE subscription supports user equipment (UE) capability update via a tracking area update (TAU) procedure;
in response to determining that the first communication network supports UE capability update via a TAU procedure, initiate the TAU procedure on the first LTE subscription with the first communication network; and
report a UE category 1 capability to the first communication network on the first LTE subscription for the mobile communication device during the TAU procedure on the first LTE subscription.

9. The mobile communication device of claim 8, wherein:
in response to determining that the first communication network does not support UE capability update via a TAU procedure, the control unit is configured to:
initiate a detach/re-attach procedure for the first LTE subscription on the first communication network; and
report the UE category 1 capability on the first LTE subscription for the mobile communication device during a re-attach portion of the detach/re-attach procedure for the first LTE subscription.

10. The mobile communication device of claim 9, wherein the control unit is further configured to assign one RX chain of the plurality of RX chains to the first LTE subscription.

11. The mobile communication device of claim 8, wherein the control unit is configured to:
determine whether a second communication network associated with the second LTE subscription supports UE capability update via a TAU procedure;
in response to determining that the second communication network supports UE capability update via a TAU procedure, initiate the TAU procedure on the second LTE subscription to the second communication network; and
report a UE category 4 capability on the second LTE subscription for the mobile communication device during the TAU procedure on the second LTE subscription.

12. The mobile communication device of claim 11, wherein the control unit is configured to:
in response to determining that the second communication network does not support UE capability update via a TAU procedure,
initiate a detach/re-attach procedure for the second LTE subscription on the second communication network; and
report the UE category 4 capability on the second LTE subscription for the mobile communication device during a re-attach portion of the detach/re-attach procedure for the second LTE subscription.

13. The mobile communication device of claim 12, wherein the control unit is configured to:
assign two RX chains of the plurality of RX chains to the second LTE subscription.

14. A method for receiving a Voice over Long Term Evolution (VoLTE) call on a user equipment (UE) multi subscriber identity module multi-active (MSMA) mobile communication device having less than four receive chains and a dedicated data subscription (DDS) set to a first subscription, the method comprising:
entering traffic mode by the first subscription associated with a first communication network;
reporting a first rank indicator equal to one for the mobile communication device to the first communication network on the first subscription without determining channel conditions;
determining channel conditions for the first subscription based on one or more measured channel parameters; and
in response determining that the one or more measured channel parameters are equal to or greater than a threshold value, assigning one receive chain to the first subscription.

15. The method of claim 14, further comprising:
in response determining that the one or more measured channel parameters are not equal to or greater than the threshold value, assigning two receive chains to the first subscription.

16. The method of claim 15, further comprising:
with the two receive chains assigned to the first subscription, reporting the first rank indicator equal to one for the mobile communication device to the first communication network on the first subscription.

17. The method of claim 15, further comprising:
when a second subscription associated with a second communication network is already in traffic mode,
reporting a second rank indicator for the mobile communication device to the second communication network on the second subscription according to a remaining number of receive chains on the mobile communication device.

18. The method of claim 17, wherein the VoLTE call is given a higher priority in assignment of the receive chains.

19. The method of claim 14, wherein the one or more measured channel parameters comprise at least one of reference signal received power (RSRP) and signal to noise ratio (SNR).

20. The method of claim 14, wherein each subscription supports LTE category 4.
